(19) United States
(12) Patent Application Publication
(10) Pub. No.: US 2015/0310437 A1
(43) Pub. Date: Oct. 29, 2015

(54) AVOIDING TRANSACTION ROLLBACK

(71) Applicant: International Business Machines Corporation, Armonk, NY (US)

(72) Inventors: Jiu Z. Han, Beijing (CN); Qi N. Li, Beijing (CN); Yi X. Song, Beijing (CN); Shuang Yu, Beijing (CN)

(21) Appl. No.: 14/676,875

(22) Filed: Apr. 2, 2015

(30) Foreign Application Priority Data
Apr. 29, 2014 (CN) 201410178265.0

(51) Int. Cl. G06Q 20/40

(52) U.S. Cl. CPC G06Q 20/405; G06Q 20/407

(57) ABSTRACT

A method and apparatus for avoiding a transaction rollback is provided. The method includes, at a predetermined checkpoint in a currently executing business process, determining the current service, and determining at least one service in subsequent processes of the checkpoint. The status of at least one unavailable service in the at least one service included in the subsequent processes of the checkpoint is queried. Whether the transaction can be fulfilled is determined, based on the at least one unavailable service. The execution of the transaction is stopped in response to a judgment that the transaction cannot be fulfilled.

### BACKGROUND

The present invention relates to computer network application, and more particularly, to a business process executed using the computer network.

Complex applications executing in a computer network environment, such as online shopping applications, portal sites, and virtual malls, often include a plurality of independent services, together executing as a transaction. In this context, a transaction may also be referred to as an execution of a business process, such as starting with a user browsing goods on a website through to the user checkout and order completion. A business process includes several services to perform the various flows of business logic. For example, the flow of the ProcessOrder business logic flow may include the calling sequence and parameters of the ReserveInventory, ProcessPayment, TransferOrder, and FulfillOrder services. The services within the business process generally include a plurality of units of software program code.

These services may be provided by an internal service of a business enterprise, i.e. from within the business enterprise, or from an external service, i.e. from outside of the business enterprise. For example, a credit card payment servicer may represent an external service to a non-profit organization's website for accepting donations. When an internal or external service that is called during the processing of the transaction is unavailable, the services that have already successfully completed before reaching the unsuccessful service in the transaction are rolled back. The rollback of services may be costly in terms of performance, especially at the external system. For example, some payment gateways initiate a “refund” compensation service after a “paid” compensation service. In this case, the merchant would incur a fee twice, once for each compensation service in the payment transaction. Further, some services provided by external systems may not support rolling back the completed service without manual intervention, thus increasing labor costs.

### SUMMARY OF THE INVENTION

A method and apparatus for avoiding a transaction rollback is provided, according to one embodiment of the present disclosure. The method may include, at a predetermined checkpoint in a business process which a currently executed transaction is in, determining at least one service included in subsequent processes of the checkpoint. At least one unavailable service in the at least one service included in the subsequent processes of the checkpoint is queried. The method may judge whether the transaction can be fulfilled based on the at least one unavailable service. The executing of the transaction may be stopped in response to a judgment that the transaction cannot be fulfilled.

An apparatus for avoiding a transaction rollback, is provided. The apparatus may include a service determining unit configured to, at a predetermined checkpoint in a business process which a currently executed transaction is in, determine at least one service included in subsequent processes of the checkpoint. The apparatus provides a service status querying unit configured to query at least one unavailable service in the at least one service included in the subsequent processes determined by the service determining unit. The apparatus provides a transaction executability judging unit configured to judge whether the transaction can be fulfilled based on the at least one unavailable service queried by the service status querying unit. The apparatus provides a transaction execution control unit configured to stop an execution of the transaction in response to a judgment of the transaction executability judging unit that the transaction cannot be fulfilled.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description.

FIG. 1 shows a block diagram of an exemplary computer system/server which is applicable to implement the embodiments of the present disclosure.

FIG. 2 shows a flowchart of an exemplary shopping website transaction.

FIG. 3 shows a flowchart of an OrderSubmission detail of the exemplary shopping website transaction of FIG. 2.

FIG. 4 shows a flowchart of a method for avoiding a transaction rollback according to embodiments of the present disclosure.

FIG. 5 shows a block diagram of an apparatus for avoiding a transaction rollback according to embodiments of the present disclosure.

### DETAILED DESCRIPTION

In the following detailed description of embodiments of the invention, reference is made to the accompanying drawings, which illustrate example embodiments by which the invention may be practiced. It is to be understood that other embodiments may be utilized and structural changes may be made without departing from the scope of the invention.

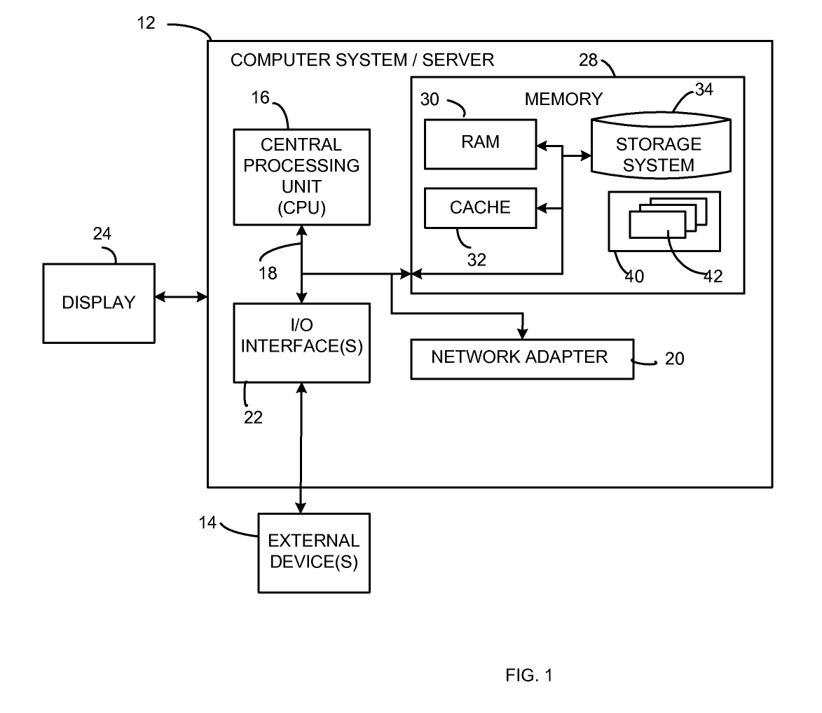

Referring now to FIG. 1, in which an exemplary computer system/server 12 which is applicable to implement the embodiments of the present invention is shown. Computer system/server 12 is only illustrative and is not intended to suggest any limitation as to the scope of use or functionality of embodiments of the invention described herein.

FIG. 1, is a block diagram of an exemplary computer system/server (i.e., server) 12 operable for various embodiments of the disclosure is presented. The computer system/server 12 shown in FIG. 1 is applicable to implement various embodiments of the present disclosure.

The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable storage devices. Such storage devices may be any available storage device that is accessible by computer system/server 12, and it includes both volatile and non-volatile storage devices, removable and non-removable storage devices.

System memory 28 can include computer system readable media in the form of volatile memory, such as random access memory (RAM) 30 and/or cache memory 32. Computer system/server 12 may further include other removable/non-removable, volatile/non-volatile computer system storage devices. By way of example only, storage system 34 can be provided for reading from and writing to a non-removable, non-volatile magnetic storage device (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical device can be provided. In such instances, each can be connected to bus 18 by one or more data device interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

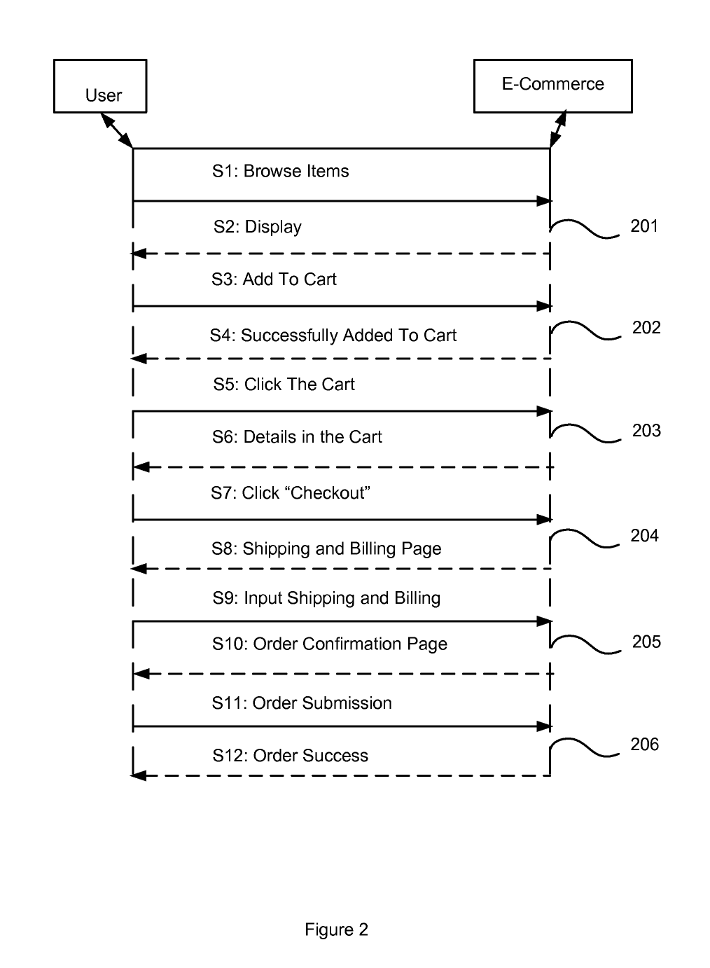

FIG. 2 schematically shows a flowchart 200 of an exemplary shopping website business process, also referred to as a transaction. A business process may be further divided into a plurality of flows of business logic, such as ProcessOrder. The business logic flow includes several services that may be called to execute various flows of the business logic flow. The services may further include a plurality of units of software program code, i.e., modules and submodules. As shown in the business process 200 of FIG. 2, business logic flows are indicated as 201, 202, 203, 204, 205, and 206, each of which may include a plurality of services, each performed by a plurality of modules and submodules.

The left side of FIG. 2 represents a user and the right side represents a shopping website. The arrows between the user and the website represent user-initiated interactions between the user and the website. The arrows pointing from the website to the user represent operations of the website in response to one or more user-initiated actions. It may be understood that multiple instances of the transaction show in FIG. 2 may simultaneously execute on the e-commerce website.

At S1, a user enters an e-commerce website, and begins browsing for available items.

At S2, following the user entering selection criteria, such as price, size, or brand, the e-commerce website displays one or more items for the user to examine further.

At S3, in response to examining the details of the items, the user may elect to add an item to the shopping cart by clicking on a button designed to perform the function of adding items to the user's shopping cart.

At S4, the e-commerce website may display a message to the user that the selected item is successfully added to the user's shopping cart.

At S5, the user may wish to review the items selected during this interaction with the e-commerce website, by clicking on a button designed to perform the function of displaying the items in the user's shopping cart.

At S6, in response to the user selecting to review the contents of the shopping cart, the e-commerce website formats and displays the contents of the user's shopping cart.

At S7, the user may click a button to initiate a checkout process and purchase the items in the user's shopping cart.

At S8, in response to receiving a request from the user to initiate the checkout process, the e-commerce website displays a page to receive the user's shipping and billing information.

At S9, the user inputs the shipping information and billing information, such as the paymentType, and the cardBrand of any credit/debit card used, etc.

At S10, in response to verifying the user's shipping and billing information, the e-commerce website displays an order confirmation page. To confirm the order, the user may subsequently click a button designed to confirm the order.

At S11, the user may click a button that confirms the order and completes the order submission process by invoking, for example an Order Submission process of the e-commerce website.

At S12, following successful submission of the order the e-commerce website displays a page confirming that the order has been generated. The displayed page may include a vendor message and an order number.

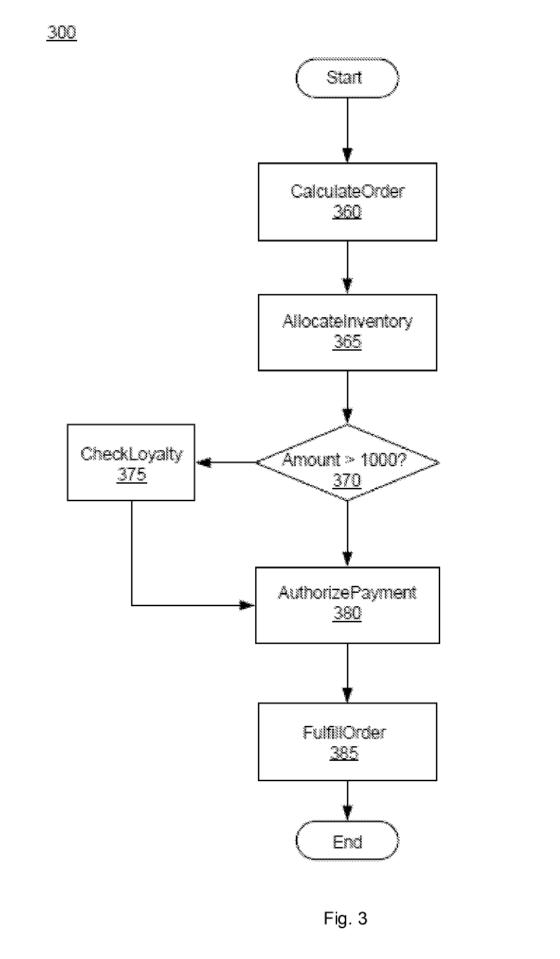

FIG. 3 shows a flowchart of the OrderSubmission 206 (FIG. 2) business logic flow 300. As shown in FIG. 3, a successful completion of the OrderSubmission business logic flow 300 also includes successful executions of several services. In this context, a service refers to a plurality of software modules and supporting computing resources. For example, the OrderSubmission business logic flow 300 calls the service CalculateOrder 360 provided by the pricing system, the service AllocateInventory 365 provided by the inventory system, the service AuthorizePayment 380 provided by the payment system, and the service FulfillOrder 385 provided by the warehouse system. At 370, if the amount of the order exceeds one thousand dollars, a business logic flow rule defined in the business process triggers a call to the service CheckLoyalty 375 that is provided by the customer relationship management (CRM).

In the OrderSubmission business logic flow 300, the CalculateOrder 360 service may represent an internal service, since the service is provided by a pricing system inside the shopping website. The AuthorizePayment 380 service may represent an external service since it is provided by an external payment system integrated with the shopping website and belongs to the external service.

Those skilled in the art of the business process application field, may refer to a transaction as an instance of the business process. For example, with reference to FIG. 2, when a user enters an e-commerce website (S1), an instance of the business process 200 is started. The business process 200 triggers the calling and execution of a series of business logic flows, each of which is associated with a plurality of services. For example, if the user decides to submit an order (S11), an instance of the OrderSubmission business logic flow 300 is started, which triggers the calling and execution of a series of associated services defined by the business logic flow 300.

Transaction rollback is a term in the transaction management field that refers to an orderly termination of a transaction when a processing exception occurs at a node of the business logic flow of the business process. In this context, each service (i.e., 360, 365, etc. of FIG. 3) may be referred to as a node. For abnormal termination exception processing, all execution statuses (i.e., results) from nodes completed prior to the exception node are restored to their pre-transaction statuses, thereby keeping the atomicity and consistency of the whole transaction. A Service Registration Table, such as Table 1, may identify the services, i.e., nodes, in a business logic flow to enable rollback of the transaction. Exemplary Table 1 for the services in business logic flow 300, identifies the service by name, the provider of the service, e.g., a CRM system, and one or more optional input and output parameters.

TABLE 1
Service Registration Table

| Record | Service Identifier | Service Provider | Parameter |
|---|---|---|---|
| 1 | CalculateOrder | Pricing | Output: Amount |
| 2 | AllocateInventory | Inventory | Output: |
| | | | fulfillmentCenterId |
| 3 | CheckLoyalty | CRM | |
| 4 | AuthorizePayment | Payment | Input: paymentType; |
| | | | cardBrand |
| 5 | FulfillOrder | Warehouse | Input: |
| | | | fulfillmentCenterId |

The CalculateOrder 360 service performs the function to calculate the price of an order. The Pricing subsystem provides the service, and provides the output parameter of Amount.

The AllocateInventory 365 service performs the function to allocate, in the inventory system, the number of items purchased in the order. An Inventory subsystem provides the service, and provides the output parameter of fulfillmentCenterId.

The CheckLoyalty 375 service performs the function to check the credit of the user in the CRM system to thereby reduce the commercial risk of unpaid orders. The CRM subsystem provides the service.

The AuthorizePayment 380 service performs the function to complete the payment authorization business logic flow. The Payment subsystem provides the service and accepts the input parameters paymentType and cardBrand.

The FulfillOrder 385 service performs the function to send the order information to corresponding warehouse centers to facilitate subsequent sorting, packaging and shipping. The Warehouse subsystem provides the service, and accepts the input parameter fulfillmentCenterId.

Other business logic flows (i.e., 201, 202, 203, 204, and 205 of FIG. 2) may be similarly defined and stored in a storage system 34 (FIG. 1) using any suitable data structure.

Various embodiments of the method of the present invention will be described below with examples.

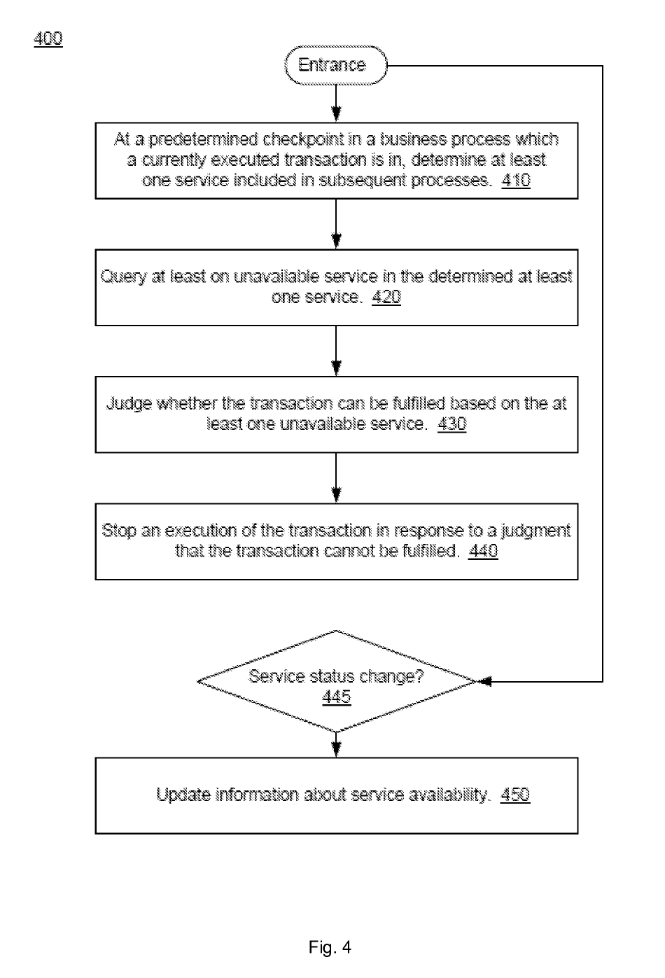

FIG. 4, schematically shows a flowchart of a method for avoiding a transaction rollback according to one embodiment of the present invention. As shown in FIG. 4, the method 400 comprises Steps 410, 420, 430 and 440.

At Step 410, at a predetermined checkpoint during a currently executing business process, at least one service included in subsequent processes of the checkpoint is determined. In this context, a checkpoint refers to a point in the business process where a transaction executability judgment is performed. Generally speaking, the checkpoint can be set at the start of the business process, before an important logic branch node, or before respective service nodes. A checkpoint can be set in advance at any node in the business process, and based on the actual running environment of the business process, the position of the checkpoint can be reset. The subsequent processes of the checkpoint refer to all business processes after the checkpoint. As an example, it is assumed that a checkpoint is set in advance at the start position of the business logic flow 300 (FIG. 3) in the business process 200 (FIG. 2).

The services included in the processes after the start position of the business logic flow 300 can be determined by querying the definition of the services included in the business process. For example, in accordance with FIG. 3 and Table 1, it can be determined that the processes after the start position of the business logic flow 300 include services 360, 365, 375, 380 and 385. The definition of the business logic flow 300 also determines information associated with the services. For example, the service registration information may indicate whether a service is an external service or an internal service, the positions on respective paths in subsequent processes, and real-time parameters associated with this execution of the service during this transaction.

After determining the services (e.g. services 360, 366, 375, 380 and 385) included in the subsequent processes of the checkpoint, at Step 420, at least one unavailable service in the at least one service included in the subsequent processes is queried for availability.

Service availability refers to whether a service is currently available. The internal or external services in the business logic flow 300 may become unavailable for various reasons, and may also be restored to available status. According to one embodiment of the present disclosure, service availability information may be recorded in real time using the exemplary data structures as shown in Table 2 (Service Availability Status Table) below.

TABLE 2
Service Availability Status Table

| | Service Identifier | Failure Associated Parameter | Availability | Error Message |
|---|---|---|---|---|
| 360 | CalculateOrder | | Y | |
| 365 | AllocateInventory | | Y | |
| 375 | CheckLoyalty | | Y | |
| 380 | AuthorizePayment | paymentType = UniPay & | N | Communication error |
| | | cardBrand = ICBC | | |
| 380 | AuthorizePayment | paymentType = UniPay & | N | not available |
| | | cardBrand = BOC | | |
| 380 | AuthorizePayment | | Y | |
| 385 | FulfillOrder | fulfillmentCenterId = Beijing | N | not available |
| 385 | FulfillOrder | | Y | |

The records shown in Table 2 include four data attributes. The meaning of the attribute Service Identifier is the same as that in Table 1. The attribute Availability indicates whether a service is available, whereby Y represents available, and N represents unavailable. The attribute Failure Associated Parameter represents associated parameters when the service fails, such as any message in the Error Message attribute.

In Table 2, the CalculateOrder 360 service has an Availability value of Y, indicating that the service is available. Similarly, the AllocateInventory 365 and CheckLoyalty 375 services are also available.

There are three records for the service AuthorizePayment 380, depending on the Failure Associated Parameter attribute. In the first case, Availability is N and the Error Message is “Communication error” and the Failure Associated Parameter is “paymentType=UniPay & cardBrand=ICBC.” This record indicates that if the paymentType is UniPay, and the cardBrand is ICBC, the service AuthorizePayment 380 is unavailable and the Error Message “Communication error” is issued.

The value of Availability of the second record for the service AuthorizePayment 380 is N and the Error Message is “not available.” This record indicates that if the paymentType is UniPay, and the cardBrand is BOC, the service AuthorizePayment 380 is unavailable and the Error Message “not available” is issued.

In the third case for the AthorizePayment 380 service, Availability is Y. There is no Failure Associated Parameter nor Error Message. This record indicates that except for the above two cases, the service AuthorizePayment 380 is available.

In another example, there are two records for the FulfillOrder 385 service. For the first record, Availability is N, the error message is “not available” and the Failure Associated Parameter is “fulfillmentCenterId=Beijing.” This record indicates that if “the fulfillment place is Beijing,” the service FulfillOrder 385 is unavailable, and the Error Message “not available” is issued. In the second record, the value of Availability is Y. There is no Failure Associated Parameter nor Error Message. This record indicates that except in the above one case, the service FulfillOrder 380 is available.

The contents shown in Table 2 indicate that in an actual application, the availability status of some services is associated with specific parameters at runtime. For example, the AuthorizePayment 380 service of the payment system is associated with the parameter (PaymentType, CardBrand) at runtime. Such a parameter is called “associated parameter” or “failure associated parameter.” Thus, the relationship between available and unavailable services and their associated parameters can be set and queried based on the value of the real-time associated parameters of the services in the transaction running process.

As shown by block 450, the method of the present invention may update service availability information in response to any service failure in the execution process of the transaction. Thus, in the case that multiple transactions of a same business logic flow are being executed, the service availability information may be updated in real time when a service failure is found in the execution process of any transaction, or when the service is restored. The service availability information may be stored in a storage system 34 (FIG. 1) using any suitable data structure.

In this case, services 360, 365, 380, 385 and 375 included in the subsequent processes of the checkpoint have been determined at Step 410. It can be learned from Table 2 that services 360, 365 and 375 are all available. Whether the AuthorizePayment service 380 is available depends on the current real-time associated parameters paymentType and cardBrand. Similarly, whether the FulfillOrder service 385 is available depends on the current real-time associated parameter fullfilmentCenterId.

According to one embodiment of the present disclosure, Step 420 of querying at least one unavailable service in the services included in the subsequent processes may further include obtaining real-time associated parameters of at least one service included in the subsequent processes, and querying unavailable services associated with the real-time associated parameters.

In general, it is possible to locate a record in Table 2 that matches the service identifier, thereby obtaining service availability information about the status of the service. According to this embodiment, it is possible to obtain, for any specific service, the current values of associated parameters of the specific service, i.e. real-time associated parameters, and to locate, based on the current values of the associated parameters, a record in Table 2 matching both the service identifier and its associated parameters, thereby obtaining the availability status of the specific service, i.e. whether the specific service is currently available.

In this case, it is assumed that the shipping information and billing information input by a user Step S9 (FIG. 2) specify the values of the parameters of the specific service AuthorizePayment 380 (FIG. 3), i.e. paymentType=Unipay, and cardBrand=ICBC, and the real-time parameters have been stored in the Service Availability Status Table before Step S11 (FIG. 2). Since paymentType and cardBrand are both failure associated parameters of the service “AuthorizePayment” 380 (FIG. 3), it is possible to first obtain, based on the name of the service “AuthorizePayment” 380 (FIG. 3), the real-time values of associated parameters paymentType and cardBrand, i.e. paymentType=Unipay, and cardBrand=ICBC, search the Service Availability Status Table (Table 2) for a record matching the specific service and the values of its failure associated parameters, and from the value N of the availability of the record, it can be learned that the AuthorizePayment 380 (FIG. 3) is currently unavailable. In a similar manner, the availability status of the FulfillOrder service 385 (FIG. 3) can be obtained.

At Step 430, whether the transaction can be fulfilled is judged based on the at least one unavailable service. Judging whether the transaction can be fulfilled refers to judging whether or not the transaction must fail after a certain checkpoint, based on the definition of the business logic flow corresponding to the transaction and the availability of the relied service at runtime. For example, if the subsequent processes of the checkpoint only include one path while there is an unavailable service on the path, it can be determined that the transaction cannot be fulfilled.

In an actual application, the subsequent processes of the checkpoint often include multiple paths. For example, in this case, it is possible to obtain from FIG. 3 the positions of the determined services 360, 365, 375, 380 and 385 in the subsequent processes, and to determine that the subsequent processes of the checkpoint include two paths. The first path is 360->365->375->380->385, and the second path is 360->365->380->385.

According to one embodiment of the present disclosure, the judging whether the transaction can be fulfilled, based on the at least one unavailable service at Step 430 may include judging whether there is an unavailable service on each path in the subsequent processes, and if there is an unavailable service on each path in the subsequent processes, then judging that the transaction cannot be fulfilled. That is to say, if the subsequent processes include multiple paths, and if none of the processes on the paths can be executed, then it can be determined that the current transaction cannot be fulfilled.

In this case, it is possible to first judge whether there is an unavailable service in the processes on the first path (360->365->375->380->385). If there is an unavailable service, then it is determined that the processes on the first path cannot be executed. If the first path is unavailable, a second path may be examined to judge whether there is an unavailable service in the processes on the second path (360->365->380->385). If there is an unavailable service, then it is determined that the processes on the second path cannot be executed.

According to one embodiment of the present disclosure, the judging whether there is an unavailable service on each path in the subsequent processes may include judging whether there is an unavailable service on a key path in the subsequent processes of the checkpoint, the key path being a common path of all paths in the subsequent processes. If there is an unavailable service on the key path in the subsequent processes, then judging that there is an unavailable service on each path in the subsequent processes.

In this case, the path 360->365 is a common path of the first path (360->365->375->380->385) and the second path (360->365->380->385), and thus is a key path. For the same reason, the path 380->385 is also a key path. A single node may also be regarded as a path, that is, service nodes 360, 365, 380 and 385 respectively may each be regarded as a path.

Since it has been determined at Step 420 that the service 380 is unavailable while the service 380 is located on the key path 380->385, there is an unavailable service on the key path in the subsequent processes, and thus it can be determined that there is an unavailable service on each path in the subsequent processes. Thus, it can be further determined that the current transaction cannot be fulfilled.

In response to a judgment that the transaction cannot be fulfilled, at Step 440 the execution of the transaction is stopped. For example, a parameter representing stopping the current transaction is returned to a master control program that executes a business logic flow of the current transaction, and subsequently the execution of the current transaction is stopped. If the transaction is not stopped, execution may continue at Step 410, that is, cyclically executing the process from Steps 410 to 440 for the next predetermined checkpoint in the business logic flow.

The checkpoint set at the beginning of the business logic flow 300 is used above as an example to describe various embodiments of the method of the present disclosure. Obviously, the aforesaid checkpoint may be set at any one or more selected positions of the business process 200, and thus it can be determined as early as possible whether the current transaction can be fulfilled. Therefore, it is possible to timely stop executing the current transaction that cannot be fulfilled.

Various embodiments implementing the method of the present disclosure have been described above with reference to the accompanying drawings. Those skilled in the art may understand that the method may be implemented in software, hardware or a combination of software and hardware. Moreover, those skilled in the art may understand that by implementing various steps in the above method in software, hardware or a combination of software and hardware, there may be provided an apparatus for avoiding a transaction rollback based on the same inventive concept. Even if the apparatus has the same hardware structure as a general-purpose processing device, the functionality of software contained therein makes the apparatus manifest distinguishing properties from the general-purpose processing device, thereby forming an apparatus of the various embodiments of the present disclosure.

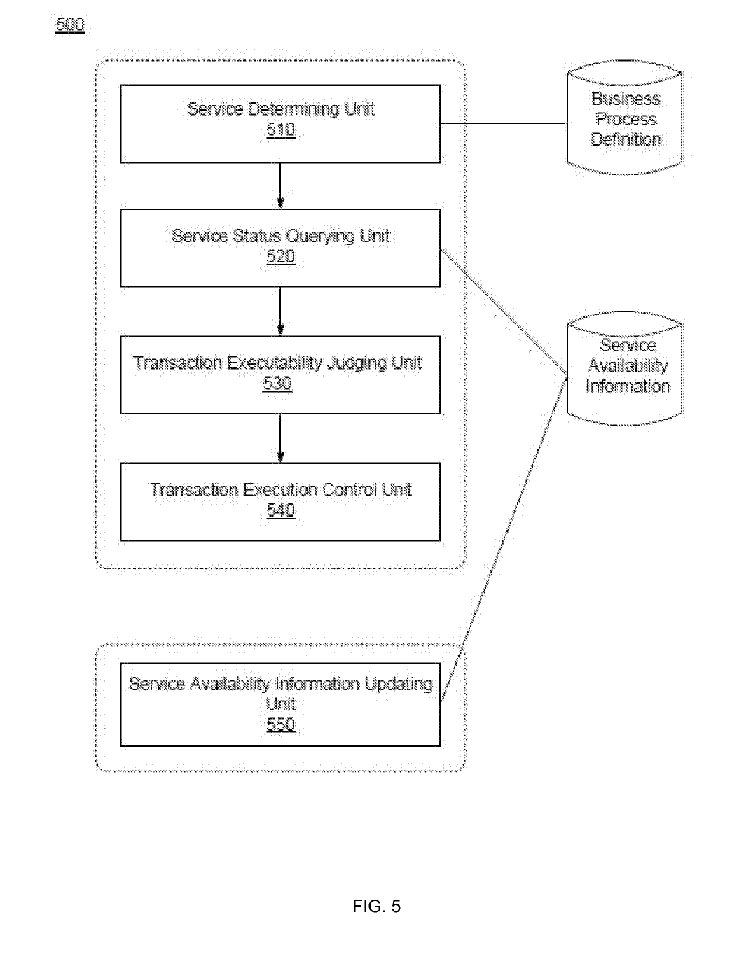

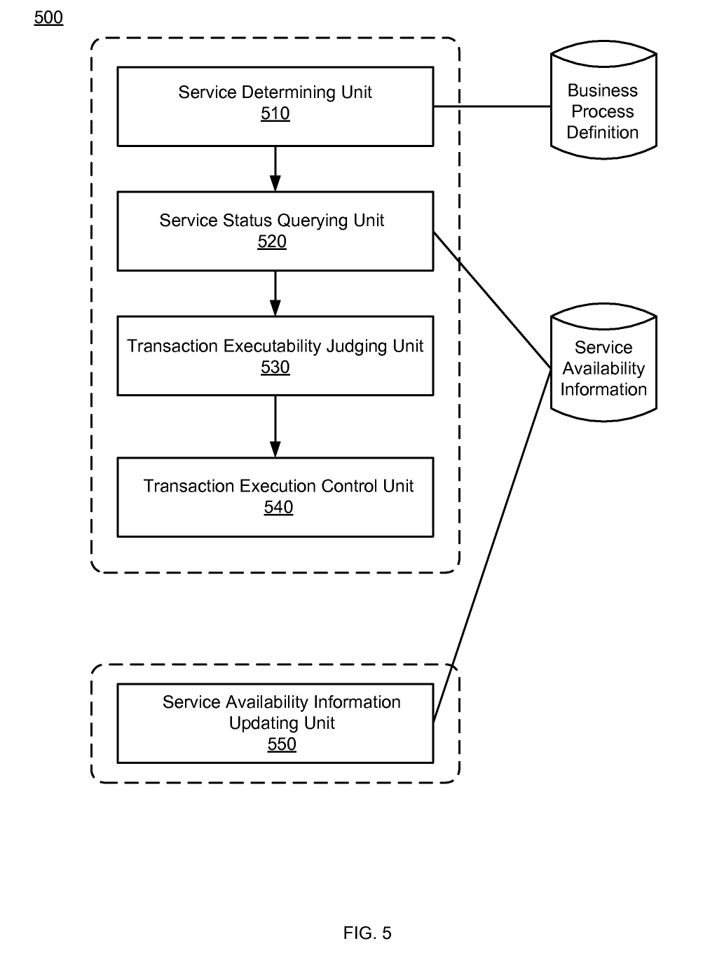

FIG. 5 schematically shows a simple block diagram of an apparatus 500 for avoiding a transaction rollback according to embodiments of the present disclosure.

As shown in FIG. 5, an apparatus 500 for avoiding a transaction rollback according to one embodiment of the present disclosure may include: a service determining unit 510, a service status querying unit 520, a transaction executability judging unit 530 and a transaction execution control unit 540.

According to one embodiment of the present disclosure, the service determining unit 510 is configured to, at a predetermined checkpoint in a currently executing business process, determine at least one service included in subsequent processes of the checkpoint. The service status querying unit 520 is configured to query at least one unavailable service in the at least one service included in the subsequent processes determined by the service determining unit. The transaction executability judging unit 530 is configured to, based on the at least one unavailable service queried by the service status querying unit, judge whether the transaction can be fulfilled. The transaction execution control unit 540 is configured to, in response to a judgment of the transaction executability judging unit 530 that the transaction cannot be fulfilled, stop an execution of the transaction.

According to one embodiment of the present disclosure, the transaction executability judging unit 530 includes: a unit configured to judge whether there is an unavailable service on each path in the subsequent processes, and a unit configured to judge that the transaction cannot be fulfilled if there is an unavailable service on each path in the subsequent processes.

According to one embodiment of the present disclosure, service status querying unit 520 includes: a unit configured to judge whether there is an unavailable service on a key path in the subsequent processes, the key path being a common path of all paths in the subsequent processes, and a unit configured to judge that there is an unavailable service on each path in the subsequent processes if there is an unavailable service on the key path in the subsequent processes.

According to one embodiment of the present disclosure, the service status querying unit 520 further includes: a parameter obtaining unit configured to obtain real-time associated parameters of at least one service included in the subsequent processes. The service status querying unit 520 is further configured to query unavailable services associated with the real-time associated parameters.

According to one embodiment of the present disclosure, the apparatus 500 further includes: a service availability information updating unit 550 configured to, in response to a change of a service status in an execution process of the transaction, update service availability information, the service availability information including unavailable services.

According to one embodiment of the present disclosure, the service availability information further includes an association relationship between the unavailable services and associated parameters.

The present disclosure described embodiments of the apparatus for avoiding a transaction rollback. In the description of the embodiments of the apparatus for avoiding a transaction rollback, the contents that are repetitions of those in the description of the method for avoiding a transaction rollback or the contents that can be derived from the above description are omitted.

With the system in various embodiments of the present disclosure, nonexecutability of the transaction processing can be found as early as possible, and the execution of the transaction processing can be terminated as early as possible so as to avoid the rollback of the service called by transaction processing.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for avoiding a transaction rollback, comprising:
at a predetermined checkpoint in a currently executing business process, determining at least one service included in subsequent processes of the checkpoint;
querying at least one unavailable service in the at least one service included in the subsequent processes of the checkpoint;
judging whether the transaction can be fulfilled based on the at least one unavailable service; and
stopping an execution of the transaction in response to a judgment that the transaction cannot be fulfilled.

2. The method according to claim 1, wherein the judging whether the transaction can be fulfilled based on the at least one unavailable service comprises:
judging whether there is an unavailable service on each path in the subsequent processes; and
judging that the transaction cannot be fulfilled based on the at least one unavailable service being on each path in the subsequent processes.

3. The method according to claim 2, wherein the judging whether there is an unavailable service on each path in the subsequent processes comprises:
judging whether there is an unavailable service on a key path in the subsequent processes of the checkpoint, the key path being a common path of all paths in the subsequent processes; and
judging that there is an unavailable service on each path in the subsequent processes based on the unavailable service being on the key path in the subsequent processes.

4. The method according to claim 1, wherein the querying at least one unavailable service in the at least one service included in the subsequent processes of the checkpoint comprises:
obtaining real-time associated parameters of at least one service included in the subsequent processes; and
querying unavailable services associated with the real-time associated parameters.

5. The method according to claim 1, further comprising:
updating service availability information in response to a change of a service status in an execution process of the transaction, the service availability information including unavailable services.

6. The method according to claim 5, wherein the service availability information further includes an association relationship between the unavailable services and associated parameters.

7. The method according to claim 1, wherein the transaction includes a plurality of internal services and a plurality of external services.

8. An apparatus for avoiding a transaction rollback, comprising:
a service determining unit configured to, at a predetermined checkpoint in a currently executing business process, determine at least one service included in subsequent processes of the checkpoint;
a service status querying unit configured to query at least one unavailable service in the at least one service included in the subsequent processes determined by the service determining unit;
a transaction executability judging unit configured to judge whether the transaction can be fulfilled based on the at least one unavailable service queried by the service status querying unit; and
a transaction execution control unit configured to stop an execution of the transaction in response to a judgment of the transaction executability judging unit that the transaction cannot be fulfilled.

9. The apparatus according to claim 8, wherein the transaction executability judging unit comprises:
a unit configured to judge whether there is an unavailable service on each path in the subsequent processes; and
a unit configured to judge that the transaction cannot be fulfilled based on an unavailable service being on each path in the subsequent processes.

10. The apparatus according to claim 8, wherein the unit configured to judge whether there is an unavailable service on each path in the subsequent processes comprises:
a unit configured to judge whether there is an unavailable service on a key path in the subsequent processes, the key path being a common path of all paths in the subsequent processes; and
a unit configured to judge that there is an unavailable service on each path in the subsequent processes based on there being an unavailable service on the key path in the subsequent processes.

11. The apparatus according to any of claim 8, wherein
the service status querying unit further comprises: a parameter obtaining unit configured to obtain real-time associated parameters of at least one service included in the subsequent processes; and
the service status querying unit is further configured to query unavailable services associated with the real-time associated parameters.

12. The apparatus according to claim 8, further comprising:
a service availability information updating unit configured to update service availability information in response to a change of a service status in an execution process of the transaction, the service availability information including unavailable services.

13. The apparatus according to claim 12, wherein the service availability information further includes an association relationship between the unavailable services and associated parameters.

14. A computer program product for avoiding transaction rollback comprising a computer readable storage medium readable by a processing circuit and storing instructions for execution by the processing circuit for performing a method comprising:
at a predetermined checkpoint in a currently executing business process, determining at least one service included in subsequent processes of the checkpoint;
querying at least one unavailable service in the at least one service included in the subsequent processes of the checkpoint;
judging whether the transaction can be fulfilled based on the at least one unavailable service; and
stopping an execution of the transaction in response to a judgment that the transaction cannot be fulfilled.

15. The computer program product according to claim 14, wherein the judging whether the transaction can be fulfilled based on the at least one unavailable service comprises:
judging whether there is an unavailable service on each path in the subsequent processes; and
judging that the transaction cannot be fulfilled if there is an unavailable service on each path in the subsequent processes.

16. The computer program product according to claim 14, wherein the judging whether there is an unavailable service on each path in the subsequent processes comprises:
judging whether there is an unavailable service on a key path in the subsequent processes of the checkpoint, the key path being a common path of all paths in the subsequent processes; and
judging that there is an unavailable service on each path in the subsequent processes if there is an unavailable service on the key path in the subsequent processes.

17. The computer program product according to claim 14, wherein the querying at least one unavailable service in the at least one service included in the subsequent processes of the checkpoint comprises:
obtaining real-time associated parameters of at least one service included in the subsequent processes; and
querying unavailable services associated with the real-time associated parameters.

18. The computer program product according to claim 14, further comprising:
updating service availability information in response to a change of a service status in an execution process of the transaction, the service availability information including unavailable services.

19. The computer program product according to claim 14, wherein the service availability information further includes an association relationship between the unavailable services and associated parameters.

20. The computer program product according to claim 14, wherein the transaction includes a plurality of internal services and a plurality of external services.
